(19) United States
(12) Patent Application Publication
(10) Pub. No.: US 2011/0280708 A1
(43) Pub. Date: Nov. 17, 2011

(54) VERTICAL AXIS WIND TURBINS

(76) Inventor: Richard Cochrane, London (GB)

(21) Appl. No.: 10/565,227

(22) PCT Filed: Jul. 26, 2004
(86) PCT No.: PCT/GB04/03257

§ 371 Date: Jun. 1, 2007

(30) Foreign Application Priority Data
Jul. 24, 2003 (GB) 0317337.4

(51) Int. Cl. F03D 3/00

(52) U.S. Cl. 415/4.4

(57) ABSTRACT

A vertical axis wind turbine comprising a shaft rotatable about a longitudinal axis and a plurality of substantially rigid blades mechanically coupled to the shaft, each of the plurality of blades comprising an elongate body having an upper and a lower end, wherein the upper end and the lower end of each blade are rotationally off-set from each other about the longitudinal axis such that each blade has a helix like form, the section of the elongate body of each blade, taken perpendicularly to the longitudinal axis, being shaped as an aerofoil having a leading edge and a trailing edge and a camber line defined between the leading edge and the trailing edge, characterized in that the aerofoil is arcuately shaped such that the camber line lies along a line of constant curvature having a finite radius of curvature.

This invention relates to vertical-axis wind turbines (VAWTs) used in general, but not exclusively, for electricity generation.

VAWTs have been known for many years. An early example is shown in U.S. Pat. No. 1,835,018 in the name of Darrieus, wherein a turbine is provided having three blades rotating about a shaft which is arranged transverse to the flow of the driving wind. Each blade has a section in the form of an aerofoil which produces dynamic lift when air is passed over the upper and lower aerofoil surfaces.

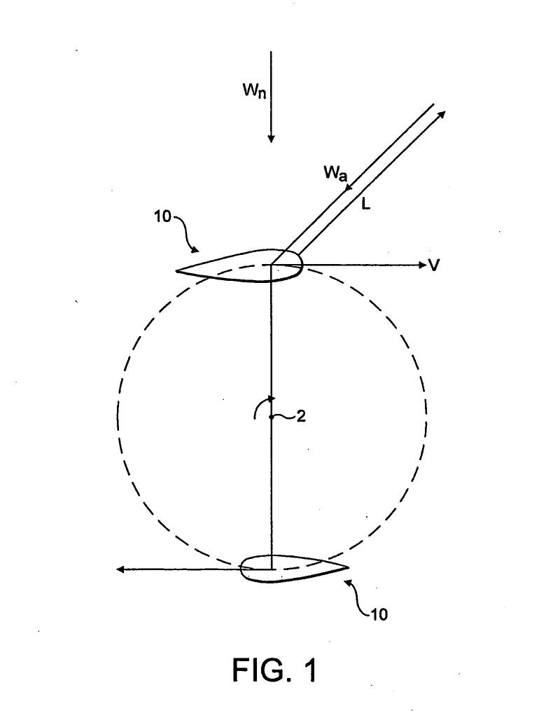

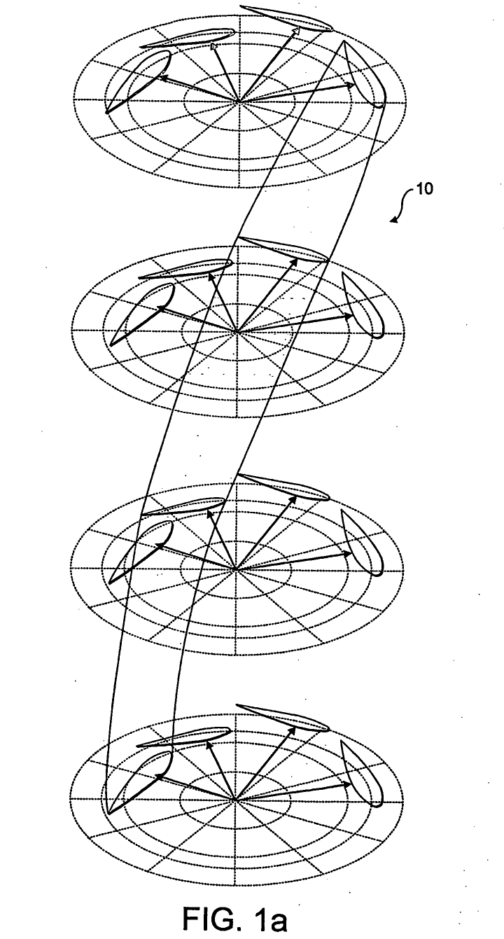

A schematic illustration of how a two-bladed VAWT works is shown in FIG. 1. Each blade 10 is configured as an aerofoil which is aligned tangentially to its local radius of rotation about a shaft 2. The nominal wind velocity is shown by arrow Wₙ and the instantaneous velocity of the upper blade 10 is shown by arrow v. In the position shown in FIG. 1 the blades 10 are moving across the wind such that the apparent wind velocity experienced by the blade is in a direction and of a magnitude as shown by arrow Wₐ. Lift produced by the aerofoil-sectioned blade is perpendicular to the apparent wind direction Wₐ and thus acts in the direction of arrow l. The component of force l acting perpendicularly to the radius of rotation of the blade acts to rotate the blade 10 about shaft 2. The generated lift acts to rotate the shaft so that the blades 10 move alternatively from positions where they actively produce lift as they cross the wind Wₙ to positions where they ‘coast’ as the blades are aligned with the wind direction Wₙ. The rotation of the shaft 2 can be used for the generation of electricity in a known manner. VAWTs have an advantage over horizontal-axis wind turbines in that they do not need to be orientated into the prevailing wind direction but are able to produce a rotational movement irrespective of the wind direction. However, VAWTs have been found to have certain technical problems.

VAWTs are prone to a number of problems. Firstly, very high stresses can be developed in the blades due to the centrifugal forces produced on rotation of the turbine at high rotational speeds. Secondly, the cutting of the blades through the air at high rotational speeds can lead to unacceptable noise levels produced by large vortices being shed at the blade tips. Thirdly, VAWTs can produce uneven torque from their lifting surfaces as the blades alternate between crossing the wind direction and ‘coasting’.

U.S. Pat. No. 5,405,246, in the name of Goldberg, describes a vertical-axis wind turbine which includes two or more elongated blades connected to a rotor tower. Each blade is “twisted” so that its lower attachment point is displaced angularly relative to its upper attachment point. The orientation of each blade is tangential to the local radius as shown in FIGS. 1a and 1b. The blade section length of each blade is disclosed as being shorter near the midpoint of each blade and longer near the ends of each blade. The ratio between the blade section length and the blade thickness is disclosed as being constant over the length of each blade. The twisting of the blades helps somewhat to even out the torque produced by the turbine during its revolution since a portion of at least one blade is crossing the wind direction at all times and thus the overall turbine is never completely in a ‘coasting’ state. However, it has been found that the design of turbine described in U.S. Pat. No. 5,405,246 can be improved upon as described below in relation to the present invention, particularly when applied to relatively compact turbines as may be desirable in urban environments.

US2001/0001299 in the name of Gorlov describes a VAWT having arcuately shaped aerofoil sections where the outermost surfaces of the blades are generally orientated to lie along a circle such that the chord (being a line joining the leading and trailing edges of the aerofoil) of each blade forms the chord of an arc of a circle. It has been found that the design described in US2001/0001299 can be improved upon as described below in relation to the present invention, particularly when applied to relatively compact turbines as may be desirable in urban environments.

It is an object of the present invention to produce a VAWT which addresses at least some of the problems described above to produce a more efficient and acceptable design and performance compared to known VAWTs.

The present invention provides a vertical-axis wind turbine comprising a shaft rotatable about a longitudinal axis and a plurality of substantially rigid blades mechanically coupled to the shaft, each of the plurality of blades comprising an elongate body having an upper end and a lower end, wherein the upper end and the lower end of each blade are rotationally off-set from each other about the longitudinal axis such that each blade has a helix-like form, the section of the elongate body of each blade, taken perpendicularly to the longitudinal axis, being shaped as an aerofoil having a leading edge and a trailing edge and a camber line defined between the leading edge and the trailing edge, characterised in that the aerofoil is arcuately shaped such that the camber line lies along a line of constant curvature having a finite radius of curvature, R′.

Preferably, the radial distance R of the camber line of each blade from the longitudinal axis varies along the length of the blade.

In one embodiment, the radius of curvature R′ of the camber line varies along the length of each blade.

Preferably, R′ is greater than or equal to 1.00R and less than or equal to 1.12R.

R′ may be approximately equal to 1.03R. Alternatively, R′ may equal R.

In one embodiment the blade shape approximates a troposkein.

Preferably the chord length of each blade varies along the length of the blade. In one embodiment the chord length of each blade is shorter towards the upper and/or lower ends relative to a central portion of each blade.

Preferably, the turbine further comprises a plurality of struts mechanically coupling the blades to the shaft. In one embodiment each blade is joined to the shaft by means of an upper strut and a lower strut. The elongate body of each blade may comprise a central portion extending between the blade's upper and lower struts, an upper portion extending above the blade's upper strut and a lower portion extending below the blade's lower strut. The upper portion of each blade may define the upper end, wherein the upper end is free-standing. The lower portion of each blade may define the lower end, wherein the lower end is free-standing. Optionally, the radial distance of the upper end and the lower end of each blade from the longitudinal axis is less than the length of the struts. In another embodiment the upper strut is joined to the upper end of each blade and the lower strut is joined to the lower end of each blade.

Preferably, the thickness-to-chord ratio of each blade is greater at or near a junction with the struts compared to the thickness-to-chord ratio of the central portion.

In one embodiment the thickness-to-chord ratio of each blade increases towards the upper and/or lower ends of the elongate body compared to the thickness-to-chord ratio of the central portion. In another embodiment the thickness-to-chord ratio of each blade is constant along the elongate body.

Preferably, the turbine comprises three blades equi-spaced about the longitudinal axis.

In one embodiment the turbine further comprises at least one strut between each blade and the rotatable shaft, wherein the strut is formed as a unitary member with the blade.

In another embodiment the turbine further comprises at least one disc-like member spanning between each blade and the rotatable shaft. Preferably, the at least on disc-like member is located at an extremity of the blades.

Optionally, each blade comprises a foam core and a composite skin.

The present invention further provides a vertical-axis wind turbine comprising a shaft rotatable about a longitudinal axis and a plurality of substantially rigid blades mechanically coupled to the shaft, each of the plurality of blades comprising an elongate body having an upper end and a lower end, wherein the upper end and the lower end of each blade are rotationally off-set from each other about the longitudinal axis such that each blade has a helix-like form, the section of the elongate body of each blade, taken perpendicularly to the longitudinal axis, being shaped as an aerofoil having a leading edge and a trailing edge and a chord line defined between the leading edge and the trailing edge, characterised in that the length of the chord line of each blade decreases towards the upper and/or lower ends relative to a central portion of each blade.

Preferably, the length of the chord line of each blade decreases towards at least a downwind end of each blade.

Embodiments of the present invention will now be described, by way of example only, with reference to the accompanying drawings in which:—

FIG. 1 is a schematic illustration, in plan view, of a rotating VAWT;

FIG. 1a is a schematic perspective view of a blade of a VAWT according to the prior art as described in U.S. Pat. No. 5,405,246;

FIG. 1b is a schematic cross-sectional view of the blade of FIG. 1a showing its cross-section at four levels;

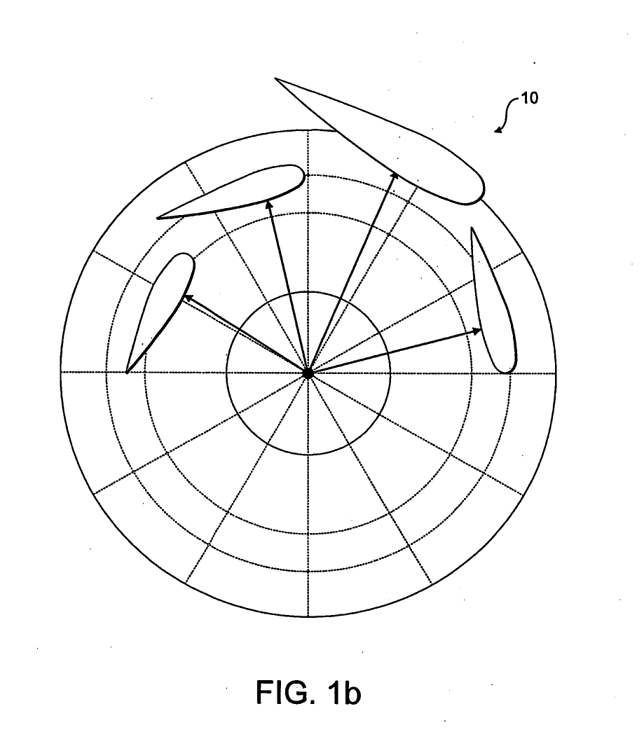

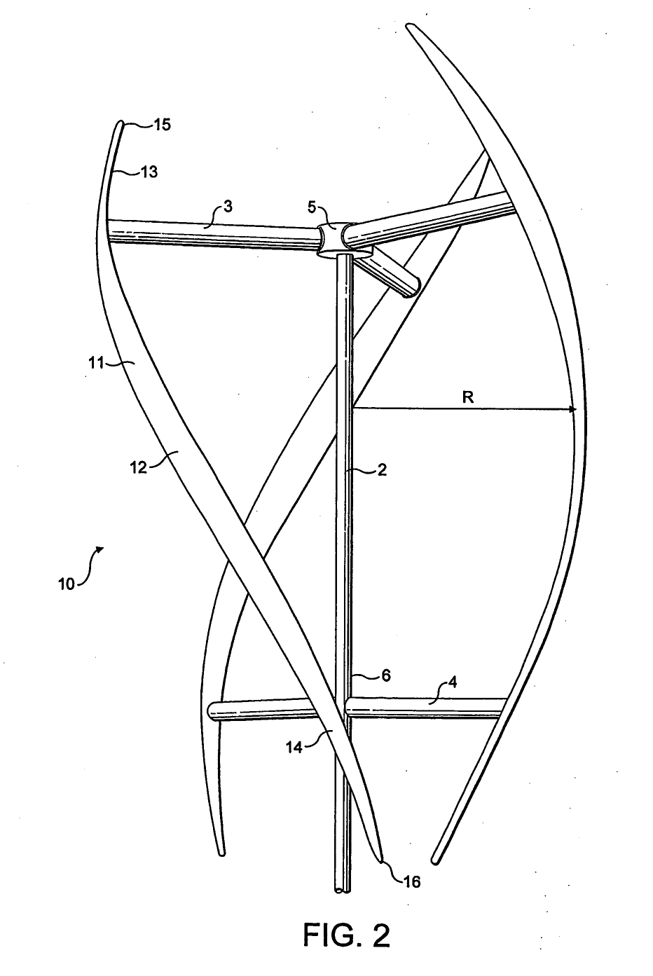

FIG. 2 is perspective view of a VAWT according to the present invention;

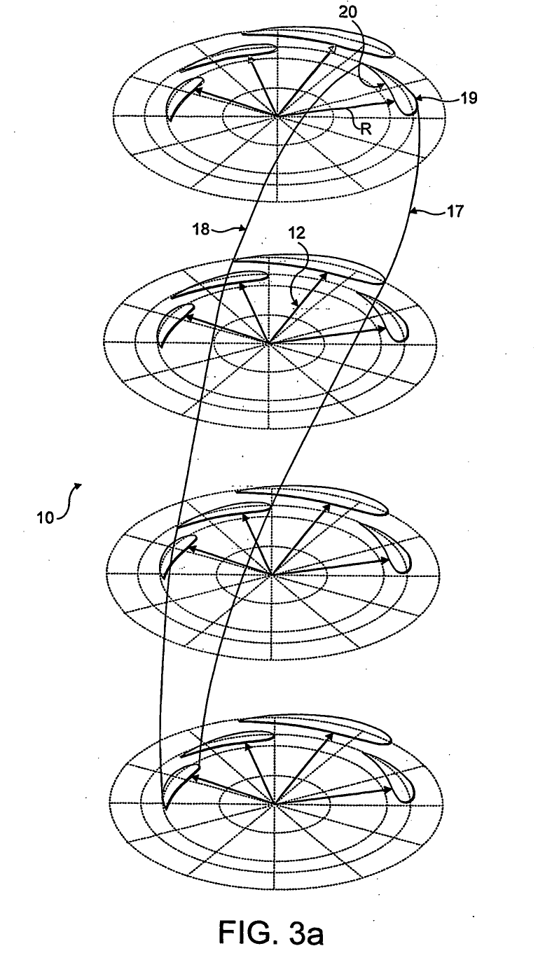

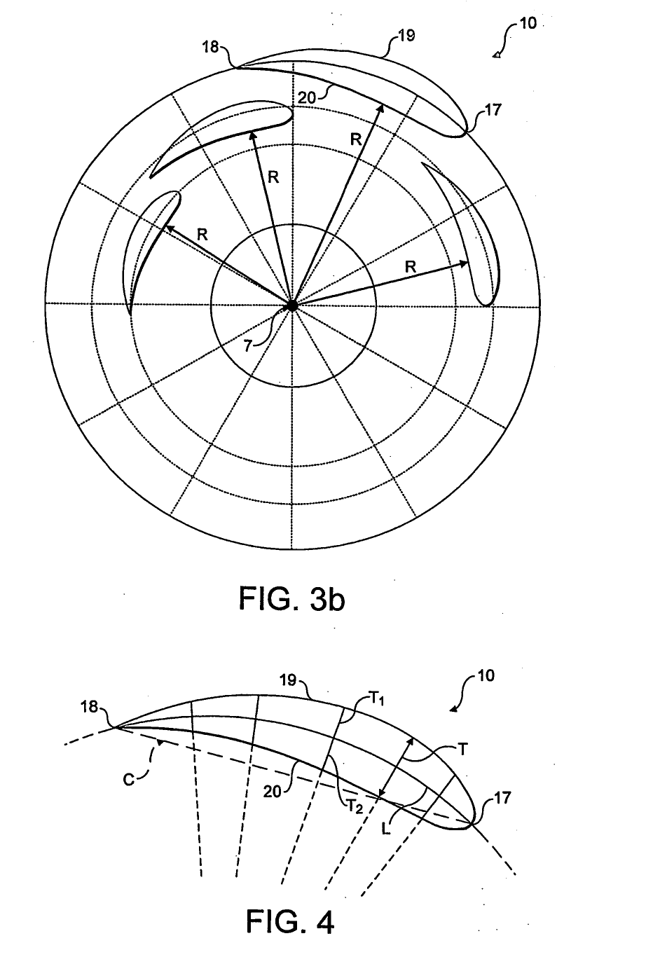

FIG. 3a is a schematic perspective view of a portion of a blade of the VAWT of FIG. 2;

FIG. 3b is a schematic cross-sectional view of the blade of FIG. 3a showing its cross-section at four levels;

FIG. 4 is a cross-sectional view through the portion of the blade shown in FIG. 3a; and

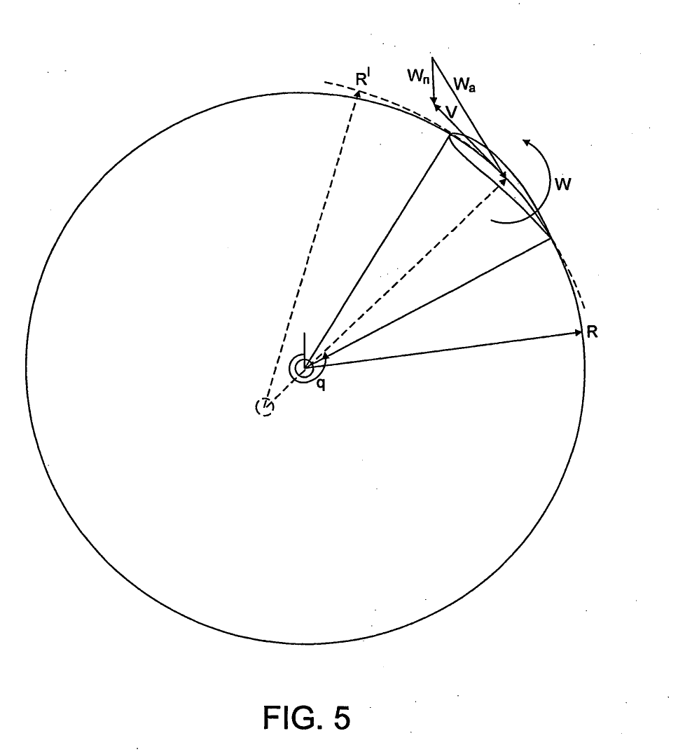

FIG. 5 is a schematic illustration, in plan view of a blade of another VAWT according to the present invention.

With reference initially to FIG. 2, the present invention provides a VAWT 1 having a rotatable shaft 2 aligned substantially along a longitudinal axis 7. Three blades 10 are mechanically coupled to the rotatable shaft 2 by means of struts 3, 4. Each blade 10 is attached to the rotatable shaft 2 by means of an upper strut 3 which joins to an upper hub 5 on the rotatable shaft 2 and a lower strut 4 which joins to a lower hub 6 on the rotatable shaft 2. The struts 3, 4 are substantially horizontal and perpendicular to the longitudinal axis 7.

Each blade 10 comprises an elongate body 11 which is twisted about the longitudinal axis 7 into a helix-like form. In consequence, the upper strut 3 of each blade 10 is rotationally off-set about the rotatable shaft 2 relative to the lower strut 4 as shown in FIG. 2. The helix-like form of the blades 10 ensures that the torque profile of the turbine 1 is smoothed out since a portion of at least one of the three blades 10 is always crossing the ambient wind Wₐ. The smoothed torque profile also reduces cyclic loading on the turbine components since the turbine is less prone to torque peaks. This reduces the fatigue loading on the components. The design also allows the turbine 1 to exhibit increased performance characteristics at low wind speeds. This makes the turbine 1 of the present invention particularly suitable for placement in urban environments where air flow speeds may be reduced and/or made more turbulent by the presence of buildings and other man-made structures.

The elongate body 11 of each blade 10 comprises a central portion 12 which extends between the upper and lower struts 3, 4, an upper portion 13 which extends above the upper strut 3 and a lower portion 14 which extends below the lower strut 4. The upper portion 13 extends upwardly to an upper tip 15 which is free-standing. The lower portion 14 extends downwardly to a lower tip 16 which is also free-standing.

The radial distance, R, of the elongate body 11 of each blade 10 from the longitudinal axis 7 varies along the length of the blade 10 as shown in FIG. 2 and schematically in FIGS. 3a and 3b. Preferably, the blades 10 are shaped in a form of a troposkein. A troposkein is that shape adopted by a flexible member held at either end and spun about an axis passing through either end. As can be seen, the radial distance R of the central portion 12 is greater than that of the upper or lower portion 13, 14. Forming the blade 10 in a troposkein shape ensures that bending movements in the blade due to the centrifugal forces are kept to a minimum.

As shown in FIG. 2, the upper end 15 and lower end 16 of the blade 10 are closer to the longitudinal axis 7 than the blade 10 at the junctions with the upper strut 3 and lower strut 4.

The attachment of the struts 3, 4 part way along the elongate body 11 of each blade 10 is advantageous in that the struts provide more even support to the blade 10. In particular, the maximum span between the struts 3, 4 is reduced compared to struts provided at the extremities of the blade 10 and thus the bending stresses in the elongate body 11 are reduced. However, the struts may, if desired be positioned at the extremities of the elongate body 11.

The blade section is shaped as an aerofoil as most clearly shown in FIGS. 3b and 4. The aerofoil section comprises a leading edge 17 and a trailing edge 18. The section also comprises an upper aerofoil surface 19 which is that surface of the blade 10 furthest from the rotatable shaft 2 and a lower aerofoil surface 20 which is that surface of the blade 10 closest to the rotatable shaft 2.

A chord, C, is definable between the leading edge 17 and the trailing edge 18 of the aerofoil section. The chord, C, is a straight line. A curved camber line L is also definable between the leading edge 17 and trailing edge 18 of the aerofoil section. As shown most clearly in FIGS. 3b and 4, the aerofoil section of the blade 10 of the present invention is shaped such that the camber line L between the leading edge 17 and the trailing edge 18 is not straight but arcuate such as to have a constant curvature having a finite radius of curvature. In other words, the aerofoil section of each blade 10 is ‘wrapped’ around a centre of curvature. Consequently, the camber line L does not lie on the chord of the aerofoil section. In the embodiment of VAWT shown in FIGS. 2 to 4 the centre of curvature coincides with the longitudinal axis of rotation 7 of the VAWT. In other words, the camber line is curved to follow the circumferential line along which the airfoil is travelling as it rotates about axis 7. As a result, the blade's rotation into the wind will be minimised. This wrapping of the airfoil section is advantageous, especially for turbines where the camber line length L is large relative to the radius of the VAWT, a design characteristic important for small turbines where the viscous aerodynamic effects may limit the use of short camber line length airfoils.

In addition, the aerofoil section is symmetrical about the camber line L. That is, along the entire aerofoil section, the distance, taken perpendicularly to the camber line (that is radially from axis 7), between the camber line L and the upper aerofoil surface 19 (shown in FIG. 4 as T₁) is the same as the distance between the camber line L and the lower aerofoil surface 20 (shown in FIG. 4 as T₂). This combination of the symmetry and wrapping of the aerofoil section increases the efficiency of lift production of the VAWT compared to prior designs. This is achieved because the aerofoil section produces lift for a longer period as it rotates about shaft 2 since as the blade section crosses the wind it appears to the wind to be symmetrical along its entire camber line thus optimising the net driving force available to rotate the VAWT. In comparison, using tangentially symmetrical blades as described in U.S. Pat. No. 5,405,246 is less efficient since the blade appears non-symmetrical to the wind since as the blade rotates the blade section effectively rotates relative to the wind direction and thus does not remain symmetrical. This phenomenon is particularly apparent where the overall diameter of the VAWT is relatively small such that the relative angle of rotation of the blade section is more pronounced during the time it takes for the blade to cross the wind.

As shown in FIG. 4, the aerofoil section defines a section thickness T. The thickness-to-chord ratio of the blades 10 preferably varies along the length of the blade. In one embodiment, the thickness-to-chord ratio is greater at or near the upper end 15 and/or lower end 16 than in the central portion 12. In particular this is advantageous where the blade 10 is tapered such that the camber line L decreases towards the blade ends, as discussed below. Increasing the thickness-to-chord ratio as the camber line decreases increases the range of angles of attack at which the wind can produce usable lift.

The thickness-to-chord ratio may also be enlarged in proximity to the junctions between the blade 10 and the upper struts 3 and lower struts 4. At this point, the relative wind speed reduces since the distance of the blade 10 from the longitudinal axis is less than near the mid-point of the central portion 12. This creates an apparent change in the angle of attack of the wind relative to the blade 10. Increasing the thickness-to-chord ratio of the blade 10 at this point increases the blade's lift co-efficient increasing the driving force of the turbine 1. The increased thickness-to-chord ratio at these points also advantageously increases the mechanical strength of the blades 10 at the junction points of the struts 3,4 where the mechanical loads imparted by the airflow are transferred to the rotatable shaft 2.

According to a further aspect of the present invention, the length of the camber line L of the blades 10 may decrease towards the upper tip 15 and/or lower tip 16 compared to the length of the camber line of the central portion 12. Thus, the length of camber line L is tapered towards each tip reducing the camber line of the aerofoil as the blade 10 wraps around the longitudinal axis 7. The tapering of the blade helps to reduce aerodynamic drag and improves the shedding of the air flow from the trailing edge 18. Instead of shedding a single or small number of large, intense vortices, the tapering produces a more gradual, less intense shedding of numerous vortices along the blade. This, in turn, reduces the noise associated with rotation of the turbine 1. This effect is most pronounced on the downwind end of the blade 10, which may be the upper or lower end of the blade 10 depending on the direction of the helix-like structure of the blades. As such, the blades 10 may be tapered only towards the downwind end of the blades.

In a further aspect of the present invention, the blade 10 may be formed in a unitary manner with the upper strut 3 and/or the lower strut 4. The unitary blade and spar unit may be formed with a foam core covered by a composite skin. The skin may be, for example, carbon or glass fibre or a mixture of the materials.

In one example of turbine according to the present invention, three blades 10 are provided, each having a helix-like form as shown in FIG. 2. The blades span a vertical height of 3 metres. The table below indicates the relative dimensions of the camber line, thickness and radius of each blade:

| | Camber line | | Radius from |
|---|---|---|---|
| | length L | Thickness T | axis |
| Upper End | 75 mm | 25 mm | 950 mm |
| Blade Centre | 200 mm | 50 mm | 1000 mm |
| Lower End | 75 mm | 25 mm | 550 mm |

As can be seen from the table, the lower end 16 is radially closer to the longitudinal axis 7 than the upper end 15.

Another embodiment of VAWT according to the present invention is shown in FIG. 5. In this embodiment, the blade is again wrapped such that the camber line L has a constant curvature but in this case the radius of curvature R′ does not necessarily equal the radius R distance of the blade from the longitudinal axis of rotation 7. It has been found that by varying the radius of curvature R′ a VAWT with increased efficiency can be obtained due to the effects of the interaction of the rotation of the VAWT blades and the prevailing wind.

If one considers the effect of the wind forces on the blade it can be seen that the speed at which the air moves over the blade changes as the blade rotates. As the blade moves into the approaching wind, the air speed is effectively increased. As it moves back with the wind the effective speed decreases. This speed can be determined as a function of q, the angle of the turbine relative to the wind direction. The air speed over the turbine, is defined to be Wₐ

Wₐ=f{v,Wₙ,q}=Wₙ*sqrt(TSR̂2+1−2·TSR·cos(90−q)

Where Wₙ is the prevailing wind speed, v is the forward velocity of the blade and q is the angle of the blade relative to the wind direction as shown in FIG. 5.

Above has been described a turbine blade which was effectively symmetrical in that its profile was wrapped about a radius of curvature R. For that blade, R is a function of the angular velocity of the blade and its forward velocity.

R=v/w

The forward velocity for the adapted blade of FIG. 5 is equal to Wₐ although the angular velocity remains as w.

The radii now required for a symmetrical blade is therefore:

R′=Wₐ/W

Wₐ changes as the blade rotates into and away from the wind so the radius which is seen to be symmetrical also changes. As it is not easy to alter the shape of the airfoil for different positions around the turbine the blade shape is optimised based on the power profile of the rotating turbine. Power, which is a function of forward velocity and apparent angle of attack peaks as the turbine blades pass perpendicular to the wind direction. At this point the velocity Wₐ=Wₙ*sqrt(TSR+1). The equivalent symmetrical radius at peak power output is therefore:

$$\begin{matrix}{R}^{′} = {W}_{a} / w \\ = {W}_{n} * sqrt ( TSR \hat{} 2 + 1 ) / ( v / R ) \\ = {W}_{a} * R * sqrt ( TSR \hat{} 2 + 1 ) / ( {W}_{n} * TSR ) \\ = R * sqrt ( TSR \hat{} 2 + 1 ) / TSR\end{matrix}$$

where TSR is the tip speed ratio of the blade defined as v/Wₙ.

For a typical TSR of say 4, the radius R′ would therefore be 1.03*R. This indicates that for peak output a radius 3% larger than that about which the turbine is rotating will have closely symmetrical performance, balancing both the upwind and the downwind power peaks.

It will be apparent that as the physical distance R of the blade section from the longitudinal axis 7 varies along the length of the blade so does the optimum radius of curvature R′ of the camber line L. Thus, the curvature of the aerofoil camber line, whilst constant at each section of the blade, varies for sections along the length of the blade.

Various modifications to the turbine of the present invention may be made without departing from the scope of the appended claims. In particular, less than three blades 10 or more than three blades 10 may be utilised. The blades 10 may be formed into a shape other than a troposkein. For example, the blades may lie on a right circular cylinder about the longitudinal axis. The blades 10 may be formed separately from the struts 3, 4 and then assembled therewith. The blades 10 may be joined to the shaft 2 by more than two struts. In particular, a third strut may be utilised in-between the upper and lower struts 3, 4. The third strut may be positioned at the mid-point of the length of the blade 10. The blades 10 may not comprise free-standing tips. Instead the upper and lower struts 3. 4 may be joined to the blades 10 at the extremities of the blades 10.

The struts 3, 4 may be replaced by circular discs which span between the rotatable shaft 2 and the blades 10 and are rotatable about the shaft. The discs may be positioned at the upper and lower extremities of the blades 10. Alternatively, the blades 10 may extend beyond the location of the discs. Use of discs can lead to enhanced airflow compared to struts. Preferably the upper and lower surfaces of the discs are planar. Alternatively, annular members may be provided spanning between the blades 10 and having spoke-like struts spanning between the blades and the rotatable shaft.

1. A vertical-axis wind turbine comprising a shaft rotatable about a longitudinal axis and a plurality of substantially rigid blades mechanically coupled to the shaft, each of the plurality of blades comprising an elongate body having an upper end and a lower end, wherein the upper end and the lower end of each blade are rotationally off-set from each other about the longitudinal axis such that each blade has a helix-like form, the section of the elongate body of each blade, taken perpendicularly to the longitudinal axis, being shaped as an aerofoil having a leading edge and a trailing edge and a camber line defined between the leading edge and the trailing edge, characterised in that the aerofoil is arcuately shaped such that the camber line lies along a line of constant curvature having a finite radius of curvature, R′.

2. A vertical-axis wind turbine as claimed in claim 1 wherein the radial distance R of the camber line of each blade from the longitudinal axis varies along the length of the blade.

3. A vertical-axis wind turbine as claimed in claim 2 wherein the radius of curvature R′ of the camber line varies along the length of each blade.

4. A vertical-axis wind turbine as claimed in claim 2 or claim 3 wherein 1.00R<=R′<=1.12R.

5. A vertical axis wind turbine as claimed in claim 4 wherein R′ is approximately equal to 1.03R.

6. A vertical-axis wind turbine as claimed in claim 4 wherein R′ equals R.

7. A vertical-axis wind turbine as claimed in any of claims 2 to 6 wherein the blade shape approximates a troposkein.

8. A vertical-axis wind turbine as claimed in any preceding claim wherein the chord length of each blade varies along the length of the blade.

9. A vertical-axis wind turbine as claimed in claim 8 wherein the chord length of each blade is shorter towards the upper and/or lower ends relative to a central portion of each blade.

10. A vertical-axis wind turbine as claimed in any preceding claim further comprising a plurality of struts mechanically coupling the blades to the shaft.

11. A vertical-axis wind turbine as claimed in claim 10 wherein each blade is joined to the shaft by means of an upper strut and a lower strut.

12. A vertical-axis wind turbine as claimed in claim 11 wherein the elongate body of each blade comprises a central portion extending between the blade's upper and lower struts, an upper portion extending above the blade's upper strut and a lower portion extending below the blade's lower strut.

13. A vertical-axis wind turbine as claimed in claim 12 wherein the upper portion of each blade defines the upper end, wherein the upper end is free-standing.

14. A vertical-axis wind turbine as claimed in claim 12 or claim 13 wherein the lower portion of each blade defines the lower end, wherein the lower end is free-standing.

15. A vertical-axis wind turbine as claimed in claim 13 or claim 14 wherein the radial distance of the upper end and the lower end of each blade from the longitudinal axis is less than the length of the struts.

16. A vertical-axis wind turbine as claimed in claim 11 wherein the upper strut is joined to the upper end of each blade and the lower strut is joined to the lower end of each blade.

17. A vertical-axis wind turbine as claimed in any of claims 10 to 16 wherein the thickness-to-chord ratio of each blade is greater at or near a junction with the struts compared to the thickness-to-chord ratio of the central portion.

18. A vertical-axis wind turbine as claimed in any preceding claim wherein the thickness-to-chord ratio of each blade increases towards the upper and/or lower ends of the elongate body compared to the thickness-to-chord ratio of the central portion.

19. A vertical-axis wind turbine as claimed in any of claims 1 to 17 wherein the thickness-to-chord ratio of each blade is constant along the elongate body.

20. A vertical-axis wind turbine as claimed in any preceding claim wherein the turbine comprises three blades equi-spaced about the longitudinal axis.

21. A vertical-axis wind turbine as claimed in any preceding claim further comprising at least one strut between each blade and the rotatable shaft, wherein the strut is formed as a unitary member with the blade.

22. A vertical-axis wind turbine as claimed in any of claims 1 to 9 further comprising at least one disc-like member spanning between each blade and the rotatable shaft.

23. A vertical-axis wind turbine as claimed in claim 22 wherein the at least on disc-like member is located at an extremity of the blades.

24. A vertical-axis wind turbine as claimed in any preceding claim wherein each blade comprises a foam core and a composite skin.

25. A vertical-axis wind turbine comprising a shaft rotatable about a longitudinal axis and a plurality of substantially rigid blades mechanically coupled to the shaft, each of the plurality of blades comprising an elongate body having an upper end and a lower end, wherein the upper end and the lower end of each blade are rotationally off-set from each other about the longitudinal axis such that each blade has a helix-like form, the section of the elongate body of each blade, taken perpendicularly to the longitudinal axis, being shaped as an aerofoil having a leading edge and a trailing edge and a camber line defined between the leading edge and the trailing edge, characterised in that the length of the camber line of each blade decreases towards the upper and/or lower ends relative to a central portion of each blade.

26. A vertical-axis wind turbine as claimed in claim 25 wherein the length of the camber line of each blade decreases towards at least a downwind end of each blade.
